(19) United States
(12) Patent Application Publication
(10) Pub. No.: US 2004/0168981 A1
(43) Pub. Date: Sep. 2, 2004

(54) Process for separating dissolved or colloidal solids from a nonaqueous solvent

(75) Inventors: Gregor Dudziak, Bonn (DE); Andreas Nickel, Wetter (DE); Kerstin Baumarth, Wuppertal (DE); Martina Mutter, Koln (DE); Olaf Strange, Koln (DE); Rafael Warsitz, Essen (DE)

Correspondence Address: Norris, McLaughlin & Marcus P.A., 30th Floor, 220 East 42nd Street, New York, NY, 10017, US

(73) Assignee: Bayer Aktiengesellschaft, Leverkusen (DE)

(21) Appl. No.: 10/774,778

(22) Filed: Feb. 9, 2004

(30) Foreign Application Priority Data
Feb. 26, 2003 (DE) 10308111.9

(51) Int. Cl. B01D 61/00

(52) U.S. Cl. 210/644; 210/650; 210/790

(57) ABSTRACT

Process for the separation of substances present in dissolved and/or colloidal form, in particular of catalysts, from solutions in a nonaqueous solvent, with the aid of a membrane, wherein the solution is passed through a membrane which has a hydrophobic coating and a mean pore size of not more than 30 nm.

The invention relates to a process for separating solids present in dissolved or colloidal form, in particular catalysts, from solutions in a nonaqueous solvent with the aid of a membrane.

### BACKGROUND OF THE INVENTION

Methods for separating dissolved small and medium-sized molecules by means of membranes from aqueous solutions are known from the prior art. EP 1 118 683 A1 describes the separation of metals and other partially or completely dissolved solids in aqueous solutions by means of membranes comprising ceramic, polymeric or metallic materials.

Ceramic membranes comprising alumina or titanium oxide, which are classified as inorganic nanofiltration membranes, can now be produced with a pore size of less than 1 nm. Owing to their chemical, mechanical and thermal stability, these microporous, ceramic membranes have a wide range of potential applications, as described in more detail by Puhlfürss et al. (Puhlfürss et al., J. Membr. Sci. 174 [2000] 123-133). This publication is also concerned with the characterization of the membrane, which has a cutoff of <500 g/mol and flow rate of pure substance of up to 20 l/(h m² bar) in an aqueous medium.

Of particular interest with regard to small and medium-sized molecules (300-1 000 g/mol) is the separation of catalysts from reaction solutions. The reaction product of catalytic reactions should subsequently be present in the permeate, i.e. should be capable of passing through the membrane unhindered.

In catalytic processes, the catalyst is scarcely consumed or not consumed at all and could therefore in theory be used as long as desired. The problem which usually arises is the loss of the catalyst over the duration of the experiment, for example when separating off the reaction product. If this loss is limited, the process costs can often be substantially reduced.

Published specification EP 0 263 953 A1 describes the retention of rhodium complex compounds which are components of the catalyst system from aqueous solutions. There, the catalysts are separated off using a polymer membrane. The material of the polymer membrane is cellulose acetate.

The patent U.S. Pat. No. 5,681,473 describes a process in which metal complex catalysts dissolved in organic solvents (homogeneous catalysis) and their ligands are separated from an organic solvent by means of organic polymer membranes (comprising polydimethylsiloxane (PDMS)).

In order to keep the catalyst in the process, it is also possible to use a process in which the catalyst is modified. Thus, numerous publications exist on the subject of catalysts, dendrimers or “chemzymes” which have been increased in molar mass, in imitation of the mode of operation and size of enzymes, using polymers (Wöltinger et al., Applied Catalysis A 221 [2001] 171-185) (Laue et al., Adv. Synth. Catal. 343(6-7) [2001] 711-720). In this way, a size difference is created between the product which is to pass through the membrane and the catalyst which is to be retained. The selectivity of the membranes is therefore sufficient. A disadvantage is the necessary chemical modification of the catalyst.

In the processes described above for the retention of catalysts increased in molar mass, in particular polymer membranes are used. The solvent stability of such polymer membranes is, however, insufficient, as described by Van der Bruggen et al., (Van der Bruggen et al. Sep. Sci. Techn. 37(4) [2002] 783-797) on the basis of long-term tests.

In addition, the swelling of polymer membranes in organic solvents is an undesired side effect of such separation processes.

Published specification) EP 1 088 587 A2 describes the use of ceramic membranes for retaining dissolved catalysts increased in molar mass in organic solvents. As a result of enlarging the catalyst, the size difference between the product to be discharged and the catalyst to be retained increases. In addition, good retention, which is not impaired by the wetting of the pore walls with the solvent, can be achieved using larger pores.

However, a ceramic membrane can be used in a truly economical manner only if the material flow rate achieved through the membrane meets industrial requirements.

The publication WO 2001/07257 A1 describes a nanoporous membrane which has a pore size of less than 3 nm and by means of which a dissolved metal complex catalyst and its ligands are to be separated from an organic solvent. The flow rate through such ceramic membranes is likewise insufficient. Tsuru et al. (J. Membr. Sci. 185 (2001) 253-261) investigated the behavior of SiO₂/ZrO₂ membranes. They varied the pore size between 1 nm and 5 nm. This too did not lead to a flow as was achieved in an aqueous solvent.

We have now discovered that the cause of this behavior is the strong hydrophilic character of the ceramic micropores, which is due to the fact that water or OH groups become attached to the oxidic surface. These micropores are not permeable to organic solvent molecules. Transport takes place via larger pores and/or defects, which occupy only a small proportion of the total pore volume. Consequently, the flow decreases in comparison with the flow of water. The retention by these larger pores or defects is substantially above the average pore size of the membrane.

There is therefore a lack of a process by means of which solids, in particular catalysts, can be retained from organic solvents with high retention and high material flow rate.

It is an object of the invention to provide a process which avoids the disadvantages of the known processes and can retain the solid (in particular catalyst) present in dissolved and/or colloidal form from a reaction solution in organic solvents with the aid of an inorganic membrane, the product-containing solvent passing unhindered through the membrane. The solid (catalyst) should as far as possible remain unchanged with regard to its size.

### SUMMARY OF THE INVENTION

The object is achieved, according to the invention, if a membrane which has been rendered hydrophobic and by means of which a high solvent flow rate, which is substantially above the material flow rate of aqueous solution through this membrane, can be generated is used in a process of the type mentioned at the outset. Surprisingly, a retention which, depending on the membrane, is less than 1 000 g/mol, in particular cases even less than 400 g/mol, has been found.

In the context of the invention, retention is understood here as meaning that a dissolved component of this molecular weight in an organic solvent is retained to an extent of at least 90% by the membrane.

The invention relates to a process for separating solids present in dissolved and/or colloidal form, in particular catalyst from solutions in a nonaqueous solvent, in particular in organic solvents, with the aid of a membrane, wherein the solution is passed through a membrane which has a hydrophobic coating and a mean pore size of not more than 30 nm.

### DETAILED DESCRIPTION

The membrane is preferably a porous membrane, particularly preferably an inorganic membrane, especially preferably a ceramic membrane, based on Al₂0₃, Ti0₂, Zr0₂ or SiO₂ or mixtures of said oxides.

The mean pore size of the membrane is in particular not more than 20 nm, preferably 2 nm to 10 nm, more preferably 2 nm to 5 nm.

The pore size is expediently chosen so that the mean pore size in the active range of the membrane is below the range of the mean molecular size of the catalyst to be separated off and above the dimensions of the product to be allowed through.

The membrane preferably has a multilayer structure. It is in particular an asymmetric membrane which consists of at least 2, in particular cases even of at least 3, layers. For example, in a three-layer structure, the substrate layer is in particular a few millimeters thick and coarse-pored with pores having a mean diameter of 1 to 10 μm, preferably 3 to 5 μm, and the intermediate layer mounted thereon is provided with a thickness of, in particular, 10 to 100 μm and has a pore size (mean diameter) of 3 to 100 nm. The separation layer has in particular a thickness of 0.5 to 2 μm and possesses pores having a mean diameter of 0.9 to 30 nm. The substantial advantage of this membrane is the uniform structure with very few defects.

The hydrophobic coating is produced on the membrane preferably by means of silanes.

Reactions of the membrane surface with silanes of the general formula R₁R₂R₃R₄Si are suitable for imparting hydrophobic properties, preferably at least one but at most three of the groups R₁ to R₄ being hydrolyzable groups, e.g. —Cl, —OCH₃ or —O—CH₂—CH₃ and/or at least one but at most three of the groups R₁ to R₄ being nonhydrolyzable groups, e.g. alkyl groups or phenyl groups, and the nonhydrolyzable substituents preferably being capable of being at least partly fluorinated for increasing the hydrophobic effect.

The modification of the ceramic membrane with the use of the water repellent described can be effected either in the liquid phase by impregnation of the membrane in a solution of the water repellent or by directing a flow of the water repellent in the gaseous phase at the membrane by using a carrier gas, for example N₂ or a noble gas.

The nonaqueous solvent is in particular an organic solvent and is particularly preferably selected from the series: alcohols, in particular methanol or ethanol, ethers, in particular tetrahydrofuran, aromatic hydrocarbons, in particular chlorobenzene or toluene, or optionally halogenated aliphatic hydrocarbons, in particular dichloromethane.

A preferred process is characterized in that the solution contains homogeneously dissolved catalysts and/or catalysts present in colloidal form, in particular catalysts selected from the group consisting of the organometallic complex compounds, and ligands of these complex compounds, particularly preferably Ru-BINAP (BINAP=2,2′-bis(diphenylphosphino)-1,1′-binaphthyl), Pd-BINAP and Rh-EtDUPHOS, or complex compounds of triphenylphosphine with palladium (e.g. Pd(OAc)₂(PPh₃)₂) or rhodium.

Further preferably suitable catalysts are selected from complex compounds of the elements of group IVA, VA, VIA, VIIA, VIIIA or IB of the Periodic Table of the Elements, particularly preferably of manganese, iron, cobalt, nickel, palladium, platinum, ruthenium, rhodium or iridium. The ligands of these complex compounds may additionally be alkylated or arylated.

The separation of the solids from the solution is preferably carried out at a temperature of −20° C. to 200° C., particularly preferably of 0° C. to 150° C.

In a preferred process, the pressure across the membrane (trarsmembrane pressure) is 2,000 to 40,000 hPa.

Depending on the choice of the starting materials and parameters, it is possible to achieve a material retention of 250 g/mol to 1 000 g/mol (depending on the solvent) with the aid of the process according to the invention.

The invention is particularly suitable for catalyst retention when carrying out a reaction in which the catalyst is present in dissolved or colloidal form and is to be retained in a reaction vessel while the reaction product is removed, in particular continuously, from the vessel. Thus, losses can be minimized and a product obtained which is free of undesired catalyst fractions.

The catalyst can moreover be present in a mixture of dissolved and undissolved fractions.

The process described above is particularly attractive from the economic point of view since the catalysts give rise to high costs in the case of fine chemicals, expensive products in small amounts as well as chemicals which are produced in large amounts. Certain processes cannot be developed or operated economically, for example, without complete catalyst recycling.

Moreover, small molecules can be concentrated in an organic solvent.

The process is furthermore suitable for the concentration and purification of solutions of active substances in the pharmaceutical industry and in biotechnology, sectors in which high purity of the products is required. The process can be combined with other purification processes, for example with chromatographic processes.

The invention is explained in more detail below, with reference to the following figures, by the examples which however do not restrict the invention.

### BRIEF DESCRIPTION OF THE DRAWING

FIG. 1 shows a schematic diagram of the separation apparatus used in the examples.

### EXAMPLES

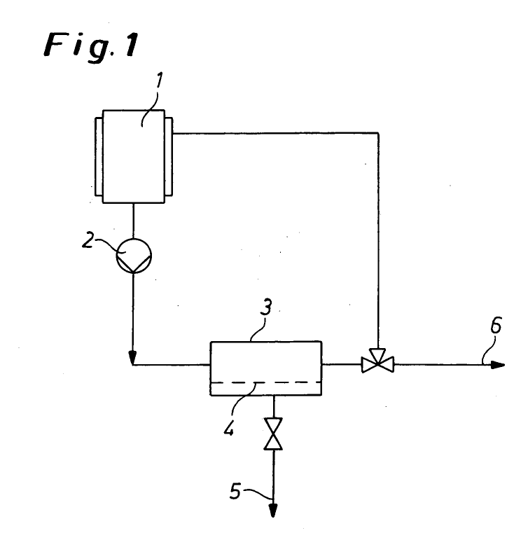

For measuring the flow rate of pure material, the corresponding solvent is introduced into the receiver 1 (cf. FIG. 1), the membrane 4 is installed in the module 3 and the solution is transported by the pump 2 and by means of pressure application in the cross-flow mode over the membrane 4. At regular intervals, a sample is taken from permeate 5 and retentate 6 and the specific flow rate in kg/(h·m²·bar) is measured.

For characterizing the cut-off of the membrane 4, the solutions are prepared according to formulation 1 to 10 (cf. tab. 1) and likewise introduced into the receiver 1. The experimental sequence corresponds to the above. The samples are measured by means of GPC analysis to determine their content of the substances used.

### Example 1

Measurement of the Flow Rate of Pure Substance

The following apparatuses were used:

Receiver 1:5 1, stainless steel, pressure-resistant to 40,000 hPa

Pump 2: Gear pump, manufacturer Garther

The experiment from example 1 was carried out in the unit described above (FIG. 1).

In this example, the flow rates of pure substance are measured for different solvents in the case of different membranes (A-D). The membranes differ in their pore sizes or cut-offs and in their surface properties. The exact description of the membranes appears in table 2. The complete experimental parameters are shown in table 3. The results are listed in table 4.

Table 4 shows the flow rates of pure substance for the different solvents.

Membrane A consists of a porous substrate comprising α-alumina having a mean pore size of 3 μm diameter, an intermediate layer comprising TiO₂ having a pore size of 5 nm and a separation layer comprising TiO₂ having a pore size of 0.9 nm without a water-repellent coating. Membrane A has a water flow rate of 16.37 kg/(h·m²·bar), a methanol flow rate of 11.54 kg/(h·m²·bar), an ethanol flow rate of 3.64 kg/(h·m²·bar) and a toluene flow rate of 1.5 kg/(h·m²·bar). Membrane B, with properties corresponding to membrane A and rendered hydrophobic with 0.5% of tridecafluoro-1,1,2,2-tetrahydrooctyltriethoysilane (referred to below as F6) and with the addition of the water repellent during the membrane synthesis, reduced the water flow rate to 10.44 kg/(h·m²·bar), the methanol flow rate to 3.12 kg/(h·m²·bar) and the toluene flow rate to 0.51 kg/(h·m²·bar).

Membrane C is a membrane which consists of the same Al₂O₃ substrate as membrane A, with an intermediate layer comprising TiO₂ having a pore size of 5 nm and a separation layer comprising ZrO₂ having a pore size of 3 nm. The imparting of hydrophobic properties is carried out by impregnation of the prepared membrane in the water repellent F6. A water flow rate of 4.48 kg/(h·m²·bar), a methanol flow rate of 16.23 kg/(h·m²·bar) and a toluene flow rate of 7.7 kg/(h·m²·bar) resulted.

Finally, the flow rate of pure substance was measured using membrane D. This corresponds to the membrane C but was treated with 0.5% of trimethylchlorosilane (referred to below as M3). A water flow rate of 1.52 kg/(h·m²·bar), a methanol flow rate of 2.48 kg/(h·m²·bar) and a toluene flow rate of 14.8 kg/(h·m²·bar) resulted.

### Example 2

Measurement of Retentions in Different Solvents

The apparatuses and the unit (FIG. 1) from example 1 were used.

In this example, the retentions of different substances in the respective solvent were measured in the case of different membranes. The substances and solvents were prepared according to formulations 1 to 10 from table 1. The membranes differ in their pore sizes or cut-offs and in their surface properties (cf. tab. 2). The complete experimental parameters are shown in table 4. The results are listed in table 5.

Membrane A has a cut-off of dextrans in water of 450 g/mol, PEG in water of 470 g/mol and PEG in methanol of 980 g/mol. The cut-off of toluene was not determined since it was not possible to measure any toluene flow through the membrane.

Membrane B has a cut-off of dextrans in water of 250 g/mol and of PEG in methanol of >1 000 g/mol. The cut-off of toluene was not determined since no toluene flow through the membrane could be measured.

Membrane C has no cut-off of dextrans in water since no water flow through the membrane could be measured. The cut-off of PEG in methanol is 1 000 g/mol and the cut-off of toluene is 500 g/mol.

Membrane D has a cut-off of dextrans in water of >2 000 g/mol and of PEG in methanol of >2 000 g/mol, and the cut-off of toluene is 340 g/mol.

### Example 3

Measurement of Catalyst Retention in Toluene

The apparatuses and the unit (FIG. 1) from example 1 were used. In this example, membrane D was used in the unit. The mixture to be separated consisted of 2.5 1 of toluene and, dissolved therein, BINAP (2,2′-bis(diphenylphosphino)-1,1 ′-binaphthyl) in a concentration of 0.132 g/l and Pd₂(dba)₃ (tris(dibenzylideneacetone)dipalladium) in a concentration of 0.0929 g/l. The complex compound Pd-BINAP having a molecular weight of at least 729 g/mol formed in this batch and was to be retained as an example substance for a catalyst. The exact experimental parameters are shown in table 3.

At a toluene flow rate of 1.1 kg/(h·m²·bar), the homogeneously dissolved complex catalyst Pd-BINAP was retained to an extent of 99.3%.

Examples 1 and 2 show that a ceramic membrane is highly hydrophilic (cf. membrane A). This is evident from the high water flow rates and good cut-offs of dextrans in aqueous solutions. The flow rates and the cut-offs decrease with increasing polarity of the solvent. Cut-offs in toluene could not be measured since the strongly hydrophilic character of the membrane pore walls did not permit wetting by the toluene so that the latter cannot flow at all through the membrane pores.

If these membranes (membrane A) having a pore size of 0.9 nm are treated with a corresponding water repellent, the water flow rate decreases but a toluene flow rate and polystyrene cut-offs once again could not be determined since the effective pore size has decreased as a result of the treatment of the pore walls. The toluene molecule itself is retained owing to its size.

In order to overcome this problem, a membrane having a correspondingly larger pore diameter was used (membrane C, dP=3 nm) and subsequently rendered hydrophobic (membrane C with 0.5% of F6 and membrane D with 0.5% of M3). The results show a greatly reduced water flow rate and simultaneously an increased toluene water flow of 7.7 and 14.8 kg/(h·m²·bar). Thus, high flow rates of organic solvents in ceramic membranes could be produced for the first time.

In example 3, one of these last-mentioned membranes (membrane D) was selected in order to carry out the catalyst experiment. The 99.3% retention of the catalyst complex shows the operability of this membrane. Although the flow rate in this example is low, a high retention is achieved. This reflects the fact that the transport through the larger pores and the defect pores was overcome, and this membrane permits processes which can be operated economically.

TABLE 1
Formulations for examples 1 and 2

| Formulation | Solvent | Starting materials | Molar masses g/mol | Concentration g/l |
|---|---|---|---|---|
| 1 | Water | Glucose | 180.2 | 0.976 |
| | | Dextran 1500 | 1 500 | 0.972 |
| | | Dextran 6000 | 6 000 | 0.97 |
| 2 | Water | Glucose | 180.2 | 0 |
| | | Lactose | 324.3 | 0.37 |
| | | Dextran 1500 | 1 500 | 0.65 |
| | | Dextran 6000 | 6 000 | 0.87 |
| | | Dextran 15000-20000 | 15 000-20 000 | 0.63 |
| | | Dextran 70000 | 70 000 | 0.49 |
| 3 | Water | Glucose | 180.2 | 0.54 |
| | | Lactose | 324.3 | 0.46 |
| | | Dextran 1500 | 1 500 | 0.81 |
| | | Dextran 6000 | 6 000 | 0.91 |
| | | Dextran 15000-20000 | 15 000-20 000 | 0.41 |
| 4 | Water | Polyethylene glycol | 1 000 | 0.5 |
| | | (PEG) 1000 | | |
| | | PEG 1500 | 1 500 | 0.5 |
| | | PEG 2000 | 2 000 | 0.5 |
| | | PEG 3000 | 3 000 | 0.5 |
| 5 | Methanol | Polyethylene glycol | 1 000 | 0.5 |
| | | (PEG) 1000 | | |
| | | PEG 1500 | 1 500 | 0.5 |
| | | PEG 2000 | 2 000 | 0.5 |
| | | PEG 3000 | 3 000 | 0.5 |
| 6 | Methanol | PEG 300 | 300 | 0.46 |
| | | PEG 600 | 600 | 0.45 |
| | | PEG 1500 | 1 500 | 0.55 |
| | | PEG 2000 | 2 000 | 0.79 |
| | | PEG 3000 | 3 000 | 0.57 |
| 7 | Methanol | PEG 300 | 300 | 0.23 |
| | | PEG 1000 | 1 000 | 0.32 |
| | | PEG 2000 | 2 000 | 0.30 |
| | | PEG 3000 | 3 000 | 0.25 |
| | | PEG 6000 | 6 000 | 0.29 |
| | | PEG 15000 | 15 000 | 0.26 |
| | | PEG 35000 | 35 000 | 0.23 |
| 8 | Ethanol | Polyethylene glycol | 000 | 0.5 |
| | | (PEG) 1000 | | |
| | | PEG 1500 | 1 500 | 0.5 |
| | | PEG 2000 | 2 000 | 0.5 |
| | | PEG 3000 | 3 000 | 0.5 |
| 9 | Toluene | Polystyrene (PS) 500 | 500 | 1 |
| | | PS 1000 | 1 000 | 1 |
| | | PS 2000 | 2 000 | 1 |
| 10 | Toluene | PS 400 | 400 | 1 |
| | | PS 500 | 500 | 1 |
| | | PS 1000 | 1 000 | 1 |
| | | PS 2000 | 2 000 | 1 |
| | | PS 5000 | 5 000 | 1 |

TABLE 2
Membranes

| | | | Treatment | Imparting of | |
|---|---|---|---|---|---|
| | Intermediate | | Sinter | hydrophobic | Characterization |
| Membrane | layer | Active layer | temperature | properties | Contact angle |
| A | TiO₂, 5 nm | TiO₂, 0.9 nm | 400° C. | None | <10° |
| B | TiO₂, 5 nm | TiO₂, 0.9 nm | 400° C. | 0.5% of F6, | 48° |
| | | | | addition during | |
| | | | | the membrane | |
| | | | | synthesis | |
| C | TiO₂, 5 nm | ZrO₂, 3 nm | 400° C. | Subsequently by | 95° |
| | | | | impregnation | |
| | | | | with F6 | |
| D | TiO₂, 5 nm | ZrO₂, 3 nm | 400° C. | Subsequently by | 38° |
| | | | | impregnation | |
| | | | | with M3 | |

TABLE 3
Experimental parameters

| | Membrane | | | | | | |
|---|---|---|---|---|---|---|---|
| | | | | Cut-off | | | |
| | | | | (R = 90%) | | | |
| | | | | Dextran in water | | | |
| | | | | before imparting | | Experimental | |
| | | | Pore | hydrophobic | | parameter | |
| | | Area | size | properties | | TMP | Temperature |
| Example | No. | m² | nm | g/mol | Material | Bar | ° C. |
| 1 | A | 0.0047 | 0.9 | 450 | TiO₂ | 4 | 23 |
| 1 | B | 0.0047 | 0.9 | 450 | TiO₂ | 4 | 23 |
| | | | | | rendered | | |
| | | | | | hydrophobic | | |
| 1 | C | 0.0047 | 3.0 | 1 000 | TiO₂/ZrO₂ | 4 | 23 |
| | | | | | rendered | | |
| | | | | | hydrophobic | | |
| 1 | D | 0.0047 | 3.0 | >2 000 | TiO₂/ZrO₂ | 5-8 | 30 |
| | | | | | rendered | | |
| | | | | | hydrophobic | | |
| 2 | A | 0.0047 | 0.9 | 450 | TiO₂ | 4-5 | 26 |
| 2 | B | 0.0047 | 0.9 | 450 | TiO₂ | 10 | 28 |
| | | | | | rendered | | |
| | | | | | hydrophobic | | |
| 2 | C | 0.0047 | 3.0 | 1 000 | TiO₂/ZrO₂ | 3-5 | 30 |
| | | | | | rendered | | |
| | | | | | hydrophobic | | |
| 2 | D | 0.0047 | 3.0 | >2 000 | TiO₂/ZrO₂ | 8 | 28 |
| | | | | | rendered | | |
| | | | | | hydrophobic | | |
| 3 | D | 0.047 | 3.0 | >2 000 | TiO₂/ZrO₂ | 9-10 | 24-28 |
| | | | | | rendered | | |
| | | | | | hydrophobic | | |

TABLE 4
Flow rates of pure substance for the different solvents
(n.d. = not determined since no flow)

| | Flow rates of pure substance | | | |
|---|---|---|---|---|
| | Water | Methanol | Ethanol | Toluene |
| Example 1 | kg/ | kg/ | kg/ | kg/ |
| Membrane | (h · m² · bar) | (h · m² · bar) | (h · m² · bar) | (h · m² · bar) |
| A | 16.37 | 11.54 | 3.64 | 1.5 |
| B | 10.44 | 3.12 | n.d. | 0.51 |
| C | 4.48 | 16.23 | n.d. | 7.7 |
| D | 1.52 | 2.48 | n.d. | 14.8 |

TABLE 5
Cut-offs of different substances in the respective solvent

| | Cut-offs Flow rates during experiment Formulations | | | | | | | | |
|---|---|---|---|---|---|---|---|---|---|
| | Dextrans | | | | | | PEG in | | |
| | in water at | Water | | PEG in water | Water | | methanol | Methanol | |
| Example 2 | R = 90% | kg/(h · | | at R = 90% | Kg/(h · | | at R = 90% | kg/ | |
| Membrane | g/mol | m² · bar) | Formulation | g/mol | m² · bar) | Formulation | g/mol | (h · m² · bar) | Formulation |

| | | | | | | | | | |
|---|---|---|---|---|---|---|---|---|---|
| A | 450 | 5.91 | 1 | 470 | 15.23 | 3 | 980 | 3.94 | 5 |
| B | 250 | 7.28 | 3 | no | | | n.d. | 4.14 | 6 |
| | | | | experiment | | | >1 000 | | |
| C | n.d. | no flow | 2 | no | | | 1 000 | 4.05 | 7 |
| | | | | experiment | | | | | |
| D | >2 000 | 2.58 | 3 | no | | | >2 000 | 3.0 | 7 |
| | | | | experiment | | | | | |

Cut-offs Flow rates during experiment Formulations

| | PEG in ethanol | | | PS in toluene | | |
|---|---|---|---|---|---|---|
| Example 2 | at R = 90% | Ethanol | | at R = 90% | Toluene | |
| Membrane | g/mol | kg/(h · m² · bar) | Formulation | g/mol | kg/(h · m² · bar) | Formulation |
| A | n.d. | 0.71 | 8 | n.d. | 0.49 | 9 |
| B | no experiment | | | n.d. | 0.31 | 10 |
| C | no experiment | | | 500 | 4.23 | 10 |
| D | no experiment | | | 340 | 2.04 | 10 |

We claim:

1. Process for the separation from a non-aqueous solvent of a substance which is present in said non-aqueous solvent in dissolved form, colloidal form, or in both of such forms, which comprises passing said non-aqueous solvent through a membrane having a hydrophobic coating and a mean pore diameter of not more than 30 nm.

2. Process according to claim 1, wherein said substance is a catalyst

3. Process according to claim 1, wherein said membrane is a porous membrane.

4. Process according to claim 3, wherein said porous membrane is an inorganic membrane.

5. Process according to claim 4, wherein said inorganic membrane is a ceramic membrane.

6. Process according to claim 5, wherein said ceramic membrane is formed of Al₂0₃, Ti0₂, Zr0₂, SiO₂ or a mixture of two or more of said oxides

7. Process according to claim 1 or 3, wherein the mean pore diameter of the membrane is not more than 20 nm.

8. Process according to claim 7, wherein said mean pore diameter is from 2 nm to 10 nm

9. Process according to claim 1 or 3, wherein said hydrophobic coating is applied by reacting the membrane surface with a silane.

10. Process according to claim 1 or 3, wherein said nonaqueous solvent is selected from the group consisting of alcohols, ethers, aromatic hydrocarbons, and optionally halogenated aliphatic hydrocarbons.

11. Process according to claim 10, wherein said alcohols are methanol or ethanol, said ethers are tetrahydrofuran, said aromatic hydrocarbons are chlorobenzene or toluene and said optionally halogenated aliphatic hydrocarbons are dichloromethane.

12. Process according to claim 2, wherein said catalyst is selected from the group consisting of the organometallic complex compounds, ligands of organometallic complex compounds and complex compounds of elements of group IVA, VA, VIA, VIIA, VIIIA or IB of the Periodic Table of the Elements.

13. Process according to claim 12, wherein said catalysts are selected from the group consisting of complex compounds of manganese, iron, cobalt, nickel, palladium, platinum, ruthenium, rhodium or iridium.

14. Process according to claim 13, wherein said complex compounds are selected from the group consisting of Ru-BINAP, Pd-BINAP, Rh-EtDUPHOS and complex compounds of triphenylphosphine with palladium or rhodium.

15. Process according to claim 1 or 3, wherein said separation is carried out at a temperature of −20° C. to 200° C.

16. Process according to claim 15, wherein said temperature is 0° C. to 150° C.

17. Process according to claim 1 or 3, wherein said process is conducted at a transmembrane pressure of from 2 000 to 40 000 hPa.
